(19) United States
(12) Patent Application Publication
(10) Pub. No.: US 2008/0208847 A1
(43) Pub. Date: Aug. 28, 2008

(54) Relevance ranking for document retrieval

(76) Inventors: Fabian Moerchen, Princeton, NJ (US); Klaus Brinker, Princeton, NJ (US); Claus Neubauer, Monmouth Junction, NJ (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/072,222

(22) Filed: Feb. 25, 2008

Related U.S. Application Data
(60) Provisional application No. 60/891,602, filed on Feb. 26, 2007.

(51) Int. Cl. G06F 17/30

(52) U.S. Cl. 707/5; 707/E17.108

(57) ABSTRACT

Documents and/or document clusters are ranked with respect to their geographical locations and/or user specific (e.g., user input) relevance. Highly relevant documents and/or document clusters are assigned higher ranks than less relevant documents and/or clusters. In this way, ranked lists of documents and/or clusters, top clusters (e.g., top stories), top documents (e.g., most important articles), etc. may be served (e.g., presented, delivered, etc.) to users.

### CROSS REFERENCE TO RELATED APPLICATIONS

This application claims the benefit of U.S. Provisional Application No. 60/891,602 filed Feb. 26, 2007, which is incorporated herein by reference. This application is related to co-pending U.S. patent application Ser. No. 12/008,886, filed Jan. 15, 2008, co-pending and concurrently filed U.S. patent application Ser. No. ______, Attorney Docket No. 2007P04113US, entitled “Online Data Clustering”, filed Feb. 25, 2008, and co-pending and concurrently filed U.S. patent application Ser. No. ______, Attorney Docket No. 2007P04117US, entitled “Document Clustering Using A Locality Sensitive Hashing Function”, filed Feb. 25, 2008, each of which is incorporated herein by reference.

### BACKGROUND OF THE INVENTION

The present invention relates generally to data clustering, and more particularly to relevance ranking for document retrieval. Clustering is the classification of items (e.g., data, documents, articles, etc.) into different groups (e.g., partitioning of a data set into subsets (e.g., clusters)) so the items in each cluster share some common trait. The common trait may be a defined measurement attribute (e.g., a feature vector) such that the feature vector is within a predetermined proximity (e.g., mathematical or numerical “distance”) to a feature vector of the cluster in which the item may be grouped. Data clustering is used in news article feeds, machine learning, data mining, pattern recognition, image analysis, and bioinformatics, among other areas.

A continuous increase in the amount and complexity of data that needs to be processed (e.g., clustered) is occurring in almost all fields of information technology. For example, the growth of the Internet has allowed rapid dissemination of news articles. News articles produced at a seemingly continuous rate are transmitted from news article producers (e.g., newspapers, wire services, etc.) to news aggregators, such as Google News, Yahoo! News, etc.

Increased access to numerous databases and rapid delivery of large quantities of information (e.g., high density data streams over the Internet) has overwhelmed the computational power and storage capacity of conventional methods of data clustering. Further, end users desire increasingly sophisticated, accurate, and rapidly delivered information relevant to the users. Such high volumes of information make it practically impossible for users to efficiently parse the data on their own. These users require some manner of determining which articles are relevant to their needs.

Therefore, alternative methods and apparatus are required to efficiently, accurately, and relevantly process large-scale streams of text documents that are grouped together into clusters with respect to content similarity and quickly produce relevant rankings of the documents and/or clusters.

### BRIEF SUMMARY OF THE INVENTION

The present invention provides a method of ranking a plurality of documents and/or clusters. Documents and/or document clusters are ranked based on features of the documents and/or features of the documents in the clusters. Such features may include document sources, distances, geographical locations, and/or user specific (e.g., user input) relevance (e.g., time of query, keywords, favorite locations, etc.). Highly relevant documents and/or document clusters are assigned higher ranks than less relevant documents and/or clusters. In this way, ranked lists of documents and/or clusters, top clusters (e.g., top stories), top documents (e.g., most important articles), etc. may be served (e.g., presented, delivered, etc.) to users.

A “document location” is determined for each document. The document location is a determination of the likely placement of the document in the world on a geographic coordinate system and is derived from information included in the document, such as references to physical locations, addresses, etc. In at least one embodiment, the document location of a document is used to determine a relevance of the document. The relevance of the document is compared to the relevancies of other documents and a ranked list of documents is produced.

In some embodiments, search queries are received from a user. Documents and/or clusters are ranked according to their relevance to the search query, among other factors such as features of the documents and/or clusters. The results of the ranking are then returned to the user.

These and other advantages of the invention will be apparent to those of ordinary skill in the art by reference to the following detailed description and the accompanying drawings.

### BRIEF DESCRIPTION OF THE DRAWINGS

FIG. 1 depicts a document ranking system according to an embodiment of the present invention;

FIG. 2 depicts a flowchart of a method of object sorting according to embodiments of the present invention;

FIG. 3 depicts a flowchart of a method of determining a relevance factor according to an embodiment of the present invention; and

FIG. 4 is a schematic drawing of a controller.

### DETAILED DESCRIPTION

The present invention generally provides methods and apparatus for relevance ranking in online document clustering. In addition to the clustering described in the above-referenced applications, sophisticated methods of selecting and ranking relevant data in document clustering systems are described herein. That is, an efficient framework for ranking of documents and document clusters is interleaved with the document clustering described in the above-referenced applications.

Documents and/or document clusters are ranked based on features of the documents and/or features of the documents in the clusters. Such features may include document sources, distances, geographical locations, and/or user specific (e.g., user input) relevance (e.g., time of query, keywords, favorite locations, etc.). Highly relevant documents and/or document clusters are assigned higher ranks than less relevant documents and/or clusters. In this way, ranked lists of documents and/or clusters, top clusters (e.g., top stories), top documents (e.g., most important articles), etc. may be served (e.g., presented, delivered, etc.) to users.

The term “document” as used herein may be interpreted as any object, file, document, article, sequence, data segment, etc. Documents, in the news article ranking and sorting embodiment described below, may be represented by document information such as their respective textual context (e.g., title, abstract, body, text, etc.) and/or associated biographical information (e.g., publication date, authorship date, source, author, news provider, location, relevance, etc.). In the following description, “documents” refers also to corresponding document information indicative of the document. One of skill in the art would recognize appropriate manners of utilizing such document information in lieu of corresponding documents.

Similarly, “cluster” as used herein may be interpreted as any grouping, association, clustering, and/or agglomeration of documents and/or document information associated with documents assigned to a cluster. Clusters, in the news article ranking and sorting embodiment described below, may be represented by cluster information indicative of the document information of the documents in the cluster and/or associated biographical information (e.g., creation date, sources, relevance, authors, news providers, locations, etc.). In the following description, “clusters” refers also to corresponding cluster information indicative of the document. One of skill in the art would recognize appropriate manners of utilizing such cluster information in lieu of corresponding clusters.

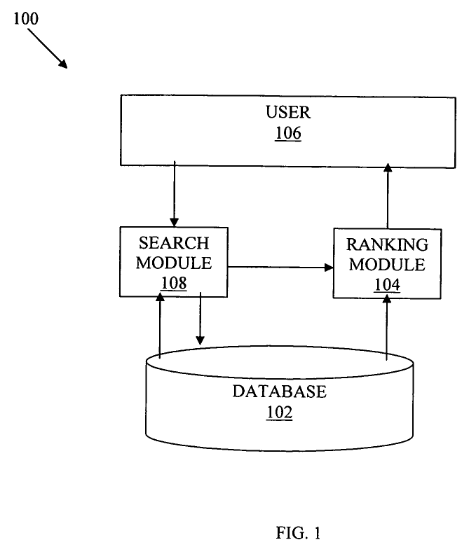

FIG. 1 depicts an exemplary document ranking system 100 according to an embodiment of the present invention. Document ranking system 100 as depicted in FIG. 1 includes data structures and logical constructs in and associated with a database system, such as a relational database system. Similarly, document ranking system 100 may be employed in connection with and/or in addition to document clustering systems described in the above-referenced related applications. Accordingly, though described herein as individual interconnected (e.g., logically, electrically, etc.) components of document ranking system 100, the various components of document ranking system 100 may be implemented in any appropriate manner, such as a database management system implemented using any appropriate combination of software and/or hardware.

Document ranking system 100 includes a database 102 for storing documents and/or information about documents (e.g., features, feature vectors, word statistics, document information, etc.) and clusters and/or information about clusters (e.g., cluster identification information, cluster objects, cluster centroids, cluster information, etc.). Document ranking system 100 further includes a ranking module 104 that receives document and/or cluster information from database 102 for ranking documents and/or clusters. Ranking module 104 may, in turn, pass ranked document and/or cluster information and/or related information to user 106. In some embodiments, user 106 may send search requests (e.g., queries, location information, etc.) to a search module 108. Search module 108 may send query information and/or related information to database 102 and/or ranking module 104. Further, database 102 may also send document and/or cluster information to search module 108.

Hardware and software implementations of the basic functions of database 102 are well known in the art and are accordingly not discussed in detail herein except as they pertain to the present invention. Database 102 may comprise memory and/or cache components and methods as well as other components and methods for implementing the functions of the present invention.

Database 102 may store information about documents and/or clusters. Such information may be related to document clustering as described in the above-referenced applications. As such, database 102 may store document information such as a document title, document text, a date and time of document publication, a date and time a document was clustered, a document's source (e.g., author, news service, etc.), a relevance measure of a source of a document, a document relevance measure, a feature vector of the document, geographical coordinates of locations referenced in a document, frequencies of references to locations in a document, a document category (e.g., sports, science, business, etc.), geographical coordinates of a document's dateline, and/or any other appropriate document information. Locations in a document may include country names, city names, state names, county names, municipality names, region names, continent names, street addresses, street names, postal addresses, zip codes, and/or any other appropriate location-based indicators. In at least one embodiment, the relevance measure of the source of the document is a value based on the circulation numbers of the source (e.g., the circulation of a newspaper, magazine, etc.) though any appropriate relevance measure may be used (e.g., predetermined weighting based on subjective source importance, etc.).

The geographical coordinates of a document are geographic coordinate pairs (latitude and longitude pairs) describing places. These places are physical locations (e.g., place names, cities, counties, regions, addresses, coordinates, etc.) referred to in the document text, headline, body, etc. and/or are related to the document and included in the document information. Such related locations included in the document information include the physical locations associated with sources (e.g., the publication city of a newspaper, the embed location of a war correspondent author, etc.). A document location is a geographic coordinate pair determined to describe the document as a whole (e.g., an average, mean, mode, etc. of the geographic coordinate pairs associated with the document).

Database 102 may also store cluster information such as a cluster centroid (e.g., a feature vector representative of the cluster), a prototypical document indicative of the cluster, document information of documents in the cluster, values (e.g., averages, selected values, common values, etc.) indicative of documents in the cluster, and/or any other appropriate document and/or cluster information. In at least one embodiment, cluster information includes cluster information representative of all of the document information in that cluster.

Similarly, the geographical coordinates of clusters are geographic coordinate pairs (latitude and longitude pairs) describing places. These places are physical locations (e.g., place names, cities, counties, regions, addresses, coordinates, etc.) referred to in the documents associated with the cluster. The places may be referenced in the associated documents texts, headlines, bodies, etc. and/or are related to the documents and included in the documents information. Such related locations included in the documents information include the physical locations associated with sources (e.g., the publication city of a newspaper, the embed location of a war correspondent author, etc.). A cluster location is a geographic coordinate pair determined to describe the cluster as a whole (e.g., an average, mean, mode, etc. of the geographic coordinate pairs associated with the cluster). In some embodiments, the cluster location is the document location of a document representative of the cluster. In alternative embodiments, the cluster location is a generalized or otherwise representative location based on the document locations of the documents associated with the cluster. That is, similarly to determining a cluster centroid, a cluster location may be generated and/or determined based on the location information of the documents associated with a cluster.

Generally, an object is either a document or a cluster or a representation of a document or a cluster. Accordingly, an object location is either a document location or a cluster location as discussed above.

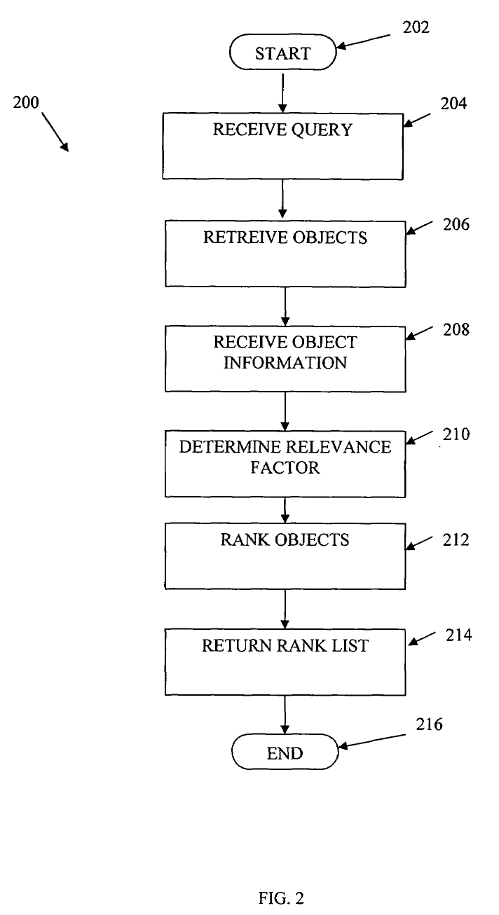

In a similar fashion, ranking module 104 and search module 108 may be implemented on any appropriate combination of software and/or hardware. Their respective functions are described in detail below with respect to the method steps of method 200 of FIG. 2.

User 106 is representative of any software and/or hardware capable of sending search queries to search module 108 and/or receiving ranked documents and/or clusters and/or other document and/or cluster information. For example, user 106 may be a computer and/or computer application at a user location configured to allow an operator to request and/or retrieve document and/or cluster information such as ranked lists of top stories (e.g., ranked lists of document clusters), ranked lists of articles (e.g., ranked lists of documents in a cluster), articles related to a specific geographical area and/or search string (e.g., ranked lists of relevant documents), stories related to a specific geographical area and/or search string (e.g., ranked lists of relevant clusters), and/or any other appropriate document and/or cluster information.

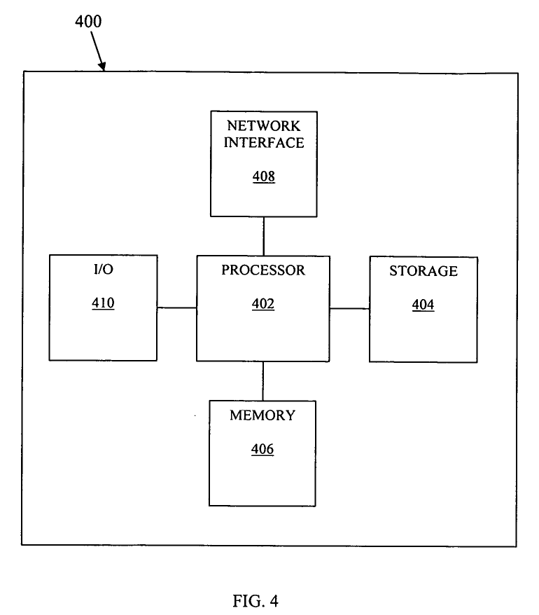

Though described as a document ranking system 100, it should be recognized that the functions of the document ranking system 100 as a whole and/or its constituent parts may be implemented on and/or in conjunction with one or more computer systems and/or controllers (e.g., controller 400 of FIG. 4 discussed below). For example, the method steps of methods 200 and 300 described below and/or the functions of database 102, ranking module 104, and/or search module 108 may be performed by controller 400 of FIG. 4 and the resultant clusters, clustered documents, relevance information, ranked lists, and/or related information may be stored in one or more internal and/or components of database 102. In the same or alternative embodiments, one or more controllers (e.g., similar to controller 400) may perform ranking of ranking module 104 and/or searching of search module 108 and a separate one or more controllers (e.g., similar to controller 400) may perform user search queries at user 106. The resultant clusters, clustered documents, relevance information, ranked lists, and/or related information may then be stored in one or more internal and/or external databases (e.g., similar to database 102).

FIG. 2 depicts a flowchart of a method 200 of object sorting according to an embodiment of the present invention. The object sorting method 200 may be performed by one or more components of document ranking system 100 such as search module 108 and/or ranking module 104. The method begins at step 202.

In step 204, a query is received. The query may be a user defined query (e.g., search, request, etc.) initiated by user 106. The query may be based on a keyword, search string, geographical location, and/or any other appropriate request. For example, a user 106 may search for stories related to topic “patents”, top stories related to “patents”, top stories for today, top stories near user 106, etc. The query may be received from user 106 at search module 108.

In step 206, objects—documents and/or clusters—are retrieved from database 102 based on the received query. In at least one embodiment, document information and/or feature vectors of documents may be retrieved from database 102 by search module 108. Also, cluster information and/or cluster centroids may be retrieved from database 102 by search module 108. That is, based on the query of step 204, a number of candidate clusters and/or candidate documents (e.g., clusters and/or documents likely to be responsive to the query) may be retrieved by the search module 108.

In step 208, information about the documents and/or clusters are received at the ranking module 106 and/or search module 108. Object information received at ranking module 106 may be received from the search module 108 and/or database 102.

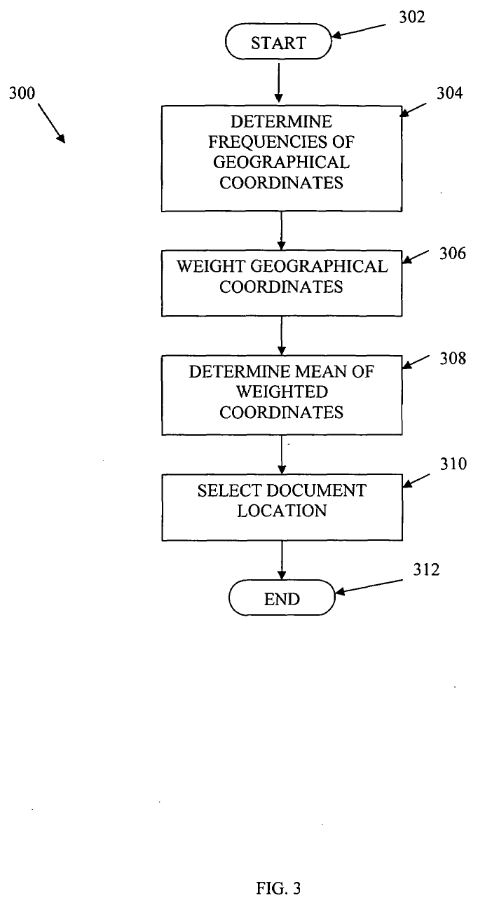

Object information may include predetermined document and/or cluster information. Such document may include a document length measured by the number of characters or words in the document, a document title length measured by the number of characters in the title, a numerical feature vector of the document, a numerical feature vector of the document title, geographical locations, a document location (discussed in further detail with respect to FIG. 3 below), a document source, a relevance measurement of the source, a relative age of the document, a numerical distance between the feature vector of the document and the cluster centroid of its associated cluster, and/or any other appropriate information as is known. Cluster information may include a size of the cluster (e.g., a number of documents in the cluster, a number of characters in the cluster, a cluster centroid, a memory storage requirement of the cluster, etc.), an age of the cluster, a conciseness measure of the cluster, sources of the documents of the cluster, relevance measures of the sources of the documents of the cluster, a diversity measure of the cluster, a numerical distance between the feature vectors of documents in the cluster and the cluster centroid, a sum of the numerical distances between the feature vectors of the documents and the cluster centroid at the time the documents were assigned to the cluster, a sum of the squared numerical distances between the feature vectors of the documents and the cluster centroid at the time the documents were assigned to the cluster, relative age measures (e.g., a relative age of the least recent document in the cluster, a relative age of the most recent document in the cluster, a number of documents per day between the least recent and the most recent document, etc.) frequencies of categories assigned to documents in the cluster, a count of the number of distinct document sources, a sum of the relevances of the document sources geographical coordinates from documents in the cluster, a cluster location, frequencies of geographical coordinates in documents in the cluster, and/or any other appropriate cluster information as is known.

Object information may be periodically and/or continually updated. That is, as new documents are added to clusters and/or new clusters are created and/or stored in database 102, document information and/or cluster information may be updated in database 102 and may thus be received at ranking module 106 and/or search module 108.

In step 210, a relevance factor is determined for the object based on the object's information. In some embodiments, relevance factors are determined for one or more documents. In other embodiments, relevance factors are determined for one or more clusters. Here, predetermined document information and/or cluster information from step 206 may be used along with dynamic information (e.g., document age, cluster age, search queries, etc.) to determine relevance factors (e.g., scores) for documents and/or clusters.

In at least one embodiment, the relevance factor is determined based on geographical information. Determining a relevance factor based on geographical information is discussed in further detail with respect to FIG. 3. In the same or alternative embodiments, the relevance factor is based at least in part on a textual relevance, which is a measure of how related a document is to a user query.

In an alternative embodiment, a relevance factor is determined for a cluster. To determine the relevance factor for the cluster, cluster information and/or document information is utilized. Cluster information includes a size (S) of the cluster where the size of the cluster is a number of documents assigned to the cluster. This gives weight to larger clusters as they may be assumed to be more relevant than smaller clusters. Cluster information also includes a conciseness measure (C) of the cluster determined as the mean value plus one standard deviation of the distances between the feature vectors of the documents of the cluster and the centroid of the cluster. The conciseness measure may also be determined from the predetermined sum of the numerical distances between the feature vectors of the documents and the cluster centroid and the sum of the squared numerical distances between the feature vectors of the documents and the cluster centroid. Cluster information also includes a diversity measure (D) of the cluster (a count of distinct sources of the documents of the cluster), and an impact sum (I) of the relevance measures of the sources of the documents of the cluster. The cluster information includes a relative age of the cluster. In some embodiments, the age is the time difference between an input time (e.g., a time of a query) and the end of the day in which a predetermined amount (e.g., 90%, 95%, etc.) of the documents in the cluster were available. In alternative embodiments, the age is the time difference between the input time and the most recent publication date and time.

Each of these pieces of cluster information may be weighted by applying a weighting factor to the cluster information. That is, the relative importance of the different pieces of cluster information may be taken into account to provide a relevance factor for the cluster. The weighting factors may be predetermined and/or updated periodically. The weighting factor for the size information may be designated SW; the weighting factor for the conciseness measure may be designated CW; the weighting factor for the diversity measure may be designated DW; the weighting factor for the impact sum may be designated IW.

The relevance factor of the cluster is then determined as

$$( \begin{matrix}( SW * rank ( S ) ) + \\ ( CW * rank ( 1 - C ) ) + \\ ( DW * min ( rank ( D ) , rank ( \frac{D}{S} ) ) ) + \\ ( IW * min ( rank ( I ) , rank ( \frac{I}{S} ) ) )\end{matrix} ) * {0.5}^{\frac{Age}{HL}}$$

where rank( ) is a function that returns a rank from a list of inputs sorted increasingly by value and min( ) is a function that returns the minimum of input values. The rank function serves to normalize the ranges of cluster information. Since the impact sum and mean impact (I/S) each describe similar properties of the cluster, the min function serves to ensure that a high relevance factor is not achieved by very small clusters with a single large impact (e.g., relevant) source or a very large cluster with a large number of small impact (e.g. relevant) sources. The half-life (HL) is a parameter that specifies a time after which a cluster with the same basic score as given by the weighted sum is only have as important. In at least one embodiment, HL is an exponential decay function with a base of 0.5. Of course, other functions and/or other bases may be used. In this way, more recent clusters will have greater relevance (e.g., importance) than less recent clusters.

In similar embodiments, the number of documents assigned to one or more categories may be incorporated into the relevance factor. In news article clustering and sorting, the relevance factor may be determined as

$$( \begin{matrix}( SW * rank ( S ) ) + \\ ( CW * rank ( 1 - C ) ) + \\ ( DW * min ( rank ( D ) , rank ( \frac{D}{S} ) ) ) + \\ ( IW * min ( rank ( I ) , rank ( \frac{I}{S} ) ) ) + \\ ( CatW * min ( rank ( Cat ) , rank ( \frac{Cat}{S} ) )\end{matrix} ) * {0.5}^{\frac{Age}{HL}}$$

wherein Cat is a category measure included in the information for the document and CatW is the weighting factor of the category measure information. In this way, certain categories (e.g., specialized news categories such as biotechnology, etc.) may be emphasized or de-emphasized. The category function may be similarly applied to emphasize or de-emphasize certain news sources. In this way, niche market sources and/or categories that produce extremely high volumes of documents may be marginalized so as to produce results more consistent with the breadth of documents, clusters, and stories.

In another embodiment, a relevance factor is determined for a document in a cluster. If the query received in step 204 is a request for a ranked list of documents within a particular cluster, each document is assigned a relevance factor. To determine the relevance factor, document information is used in coordination with cluster information to determine each document's relevance factor. Document information includes a numerical distance Dist between a feature vector of the document and a centroid of the cluster, an impact measure I of a source of the document, a document length L, and relative age information Age about the document in relation to the cluster. In such an embodiment, the age is a time differential between the date and time of the query from step 204 and a date and time of the document (e.g., the date and time the document was added to the cluster, the dated and time of document publication, etc.). The relevance factor may be determined as

$$( \begin{matrix}( DistW * rank ( 1 - Dist ) ) + \\ ( IW * \frac{rank ( I )}{S} ) + \\ ( LW * \frac{gauss ( L , {L}_{M} , STDL )}{gauss ( {L}_{M} , {L}_{M} , STDL )} )\end{matrix} ) * {0.5}^{\frac{Age}{HL}}$$

similarly to the previously described embodiment and where L_{M} is an average length of documents in the cluster and gauss( ) is a function that returns a value of a normal probability density function centered at L_{M} with a standard deviation of STDL. In this way, very short and very long documents will tend to have lower relevance factors than documents around the mean length.

In still other embodiments, a relevance factor is determined based on a query input from step 204. The relevance factor is a relevance factor of a cluster, which may be used to determine a ranked list of document clusters. Such an embodiment may be used to return a ranked list of the top stories based on a user query. The relevance factor is thus a relevance factor with respect to a search query input. Such a search query input may be a keyword query, a proximity query, and/or a combinational query.

The relevance factor of each cluster may be determined by first determining a relevance factor of each of the one or more documents based on the received query input and using the determined relevance factors of each of the documents to determine the cluster's relevance factor as

$$( \begin{matrix}( RelW * rank ( Rel ) ) + \\ ( CovW * rank ( Cov ) ) + \\ ( AgeW * rank ( \frac{1}{Age} ) )\end{matrix} ) .$$

The relevance measure (Rel) of the cluster is the average relevance score of a predetermined number (e.g., 10, 20, etc.) of the most relevant documents in the cluster. A coverage count (Cov) of a number of the documents with a determined relevance factor exceeding a predetermined threshold (e.g., 0) is also used. Here, Age is a relative age between a time of the query input receipt and an age determination of the cluster. Similarly to the weighting factors described above, RelW is a weighting factor of the relevance measure, CovW is a weighting factor of the count, and AgeW is a weighting factor of the Age.

In a similar embodiment, a relevance factor is determined based on a query input from step 204. The relevance factor is a relevance factor of a document in a cluster, which may be used to determine a ranked list of documents in the cluster. Such an embodiment may be used to return a ranked list of the top articles with respect to a particular topic or story. The relevance factor is thus a relevance factor with respect to a search query input. Such a search query input may be a keyword query, a proximity query, and/or a combinational query.

The relevance factor for the document may be determined as

$$( \begin{matrix}( RelW * rank ( Rel ) ) + \\ ( DistW * rank ( Dist ) ) + \\ ( AgeW * rank ( \frac{1}{Age} ) )\end{matrix} )$$

with the functions and variables as described above.

Variations on the embodiments of determining a relevance factor in step 206 may be used as appropriate. For example, in determining the relevance factor of a document, additional document information may be incorporated and/or weighted such as including source impact (e.g., source relevance), document length, etc.

In step 212, the object is ranked in relation to other objects based on the relevance factor by the ranking module 104. That is, after the relevance factor for a document and/or cluster has been determined in step 210, the relevance factor is compared to the relevance factor of other documents and/or clusters and the documents and/or clusters are sorted into a hierarchical list based on their relevance factors. This may include returning control of method 200 to step 204 to receive a new search query and determine a relevance factor of a different document and/or cluster in method step 210.

A ranked list of documents and/or clusters may then be returned to user 106 in step 214 based on the relevance factors. In some embodiments, in response to the query in step 204, an abbreviated list (e.g., the top story, the top 10 stories, the top article, etc.) may be returned. Alternatively, all the documents and/or clusters may be ranked and the complete ranked list may be stored in database 102 and/or served to user 106.

The method ends at step 216.

FIG. 3 depicts a flowchart of a method 300 of determining a relevance factor for a document according to an embodiment of the present invention. Determining the relevance factor in method 300 is based at least in part on geographical coordinates related to the document. The geographical coordinates may be document information indicative of geospatial coordinate pair information about places described in the document, the document's source's location, the document's byline, etc. Method 300 may be performed by document ranking system 100, specifically ranking module 104, and may be the relevance determination step 208 of method 200 described above. The method begins at step 302.

In step 304, frequencies of each of the geographical coordinates related to the document are determined. These geographical coordinates may be latitude and longitude pairs related to each instance of a location mention in the document as well as document source location information, document author location information, etc. The frequencies may be stored as an additional piece of document information in database 102.

In step 306, the geographical coordinates are weighted based on the determined frequencies. In this way, locations referenced more often in and in relation to the document are given greater importance. In step 308, a mean of the weighted geographical coordinates is determined.

In step 310, a document location is selected. In one embodiment, the document location is selected as the mean of the weighted geographical coordinates.

In another embodiment, geographical distance measures between each of the geographical coordinates and the mean of weighted geographical coordinates are determined and the geographical coordinate of the closest geographical distance measure is selected as the document location. In such embodiments, the geographical distance measure between a geographical coordinate and the mean of weighted geographical coordinates is determined as

$$2 * arc sin ( \sqrt{{sin}^{2} ( \frac{{x}_{1} - {x}_{2}}{2} ) + cos ( {x}_{2} ) {sin}^{2} ( \frac{{y}_{1} - {y}_{2}}{2} )} )$$

where x₁ is the latitude in radians of the determined mean of the weighted geographical coordinates, x₂ is the latitude in radians of the geographical coordinate, y₁ is the longitude in radians of the determined mean of the weighted geographical coordinates, and y₂ is the longitude in radians of the geographical coordinate.

In other embodiments, the document location is selected based on the mean of the weighted geographical coordinates as well as the frequencies of each of the geographical coordinates. That is, additional consideration is given to geographical coordinates with high frequencies. In this way, the document location may be selected as a geographical coordinate of a referenced location that is referenced more frequently than another geographical coordinate that is closer to the mean of the geographical coordinates or the mean of the weighted geographical coordinates. Other criteria for selecting the document location including combinations of the weighted mean of the geographical coordinates, frequencies of the geographical coordinates, and/or the unweighted mean of geographical coordinates.

The method ends at step 312. One of skill in the art will recognize that the method 300 of determining a relevance factor for a document may be extended to determining a similar relevance factor of a cluster. As discussed above, the cluster information includes information indicative of the documents associated with the cluster. Accordingly, the document information for the associated documents of a cluster may be used to determine a relevance factor for a cluster. Of course, geographical coordinates and a cluster location may be determined in a similar fashion.

FIG. 4 is a schematic drawing of a controller 400 according to an embodiment of the invention. Controller 400 may be used in conjunction with and/or may perform the functions of document clustering system 100 and/or the method steps of methods 200 and 300.

Controller 400 contains a processor 402 that controls the overall operation of the controller 400 by executing computer program instructions, which define such operation. The computer program instructions may be stored in a storage device 404 (e.g., magnetic disk, database, etc.) and loaded into memory 406 when execution of the computer program instructions is desired. Thus, applications for performing the herein-described method steps, such as determining document location and ranking documents and/or clusters, in methods 200 and 300 are defined by the computer program instructions stored in the memory 406 and/or storage 404 and controlled by the processor 402 executing the computer program instructions. The controller 400 may also include one or more network interfaces 408 for communicating with other devices via a network. The controller 400 also includes input/output devices 410 (e.g., display, keyboard, mouse, speakers, buttons, etc.) that enable user interaction with the controller 400. Controller 400 and/or processor 402 may include one or more central processing units, read only memory (ROM) devices and/or random access memory (RAM) devices. One skilled in the art will recognize that an implementation of an actual controller could contain other components as well, and that the controller of FIG. 4 is a high level representation of some of the components of such a controller for illustrative purposes.

According to some embodiments of the present invention, instructions of a program (e.g., controller software) may be read into memory 406, such as from a ROM device to a RAM device or from a LAN adapter to a RAM device. Execution of sequences of the instructions in the program may cause the controller 400 to perform one or more of the method steps described herein, such as those described above with respect to methods 200 and 300. In alternative embodiments, hard-wired circuitry or integrated circuits may be used in place of, or in combination with, software instructions for implementation of the processes of the present invention. Thus, embodiments of the present invention are not limited to any specific combination of hardware, firmware, and/or software. The memory 406 may store the software for the controller 400, which may be adapted to execute the software program and thereby operate in accordance with the present invention and particularly in accordance with the methods described in detail above. However, it would be understood by one of ordinary skill in the art that the invention as described herein could be implemented in many different ways using a wide range of programming techniques as well as general purpose hardware sub-systems or dedicated controllers.

Such programs may be stored in a compressed, uncompiled, and/or encrypted format. The programs furthermore may include program elements that may be generally useful, such as an operating system, a database management system, and device drivers for allowing the controller to interface with computer peripheral devices, and other equipment/components. Appropriate general purpose program elements are known to those skilled in the art, and need not be described in detail herein.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method of sorting objects in document clustering systems comprising:
determining an object location;
determining a relevance factor for the object based at least in part on object information including the object location; and
ranking the object in relation to one or more other objects based on the relevance factor.

2. The method of claim 1 wherein the objects are documents and determining the document location comprises:
determining a frequency of each of one or more geographical coordinates associated with the object;
weighting the geographical coordinates based on the determined frequencies;
determining a mean of weighted geographical coordinates;
determining geographical distance measures between each of the geographical coordinates and the mean of weighted geographical coordinates; and
selecting the geographical coordinate of the closest geographical distance measure as the document location.

3. The method of claim 2 wherein determining a geographical distance measure between a geographical coordinate and the mean of weighted geographical coordinates comprises:
$$determining 2 * arc sin ( \sqrt{{sin}^{2} ( \frac{{x}_{1} - {x}_{2}}{2} ) + cos ( {x}_{2} ) {sin}^{2} ( \frac{{y}_{1} - {y}_{2}}{2} )} ) wherein \text{:}$$
x₁ is the latitude in radians of the determined mean of the weighted geographical coordinates;
x₂ is the latitude in radians of the geographical coordinate;
y₁ is the longitude in radians of the determined mean of the weighted geographical coordinates; and
y₂ is the longitude in radians of the geographical coordinate.

4. The method of claim 1 wherein the objects are documents and determining the document location comprises:
determining a frequency of each of the one or more geographical coordinates;
weighting the geographical coordinates based on the determined frequencies;
determining a mean of weighted geographical coordinates; and
selecting the mean of weighted geographical coordinates as the document location.

5. The method of claim 1 wherein the objects are clusters and ranking the cluster in relation to one or more other clusters further comprises determining a most relevant cluster.

6. The method of claim 5 wherein the information for the cluster includes a size of the cluster, an age of the cluster, a conciseness measure of the cluster, sources of the documents of the cluster, relevance measures of the sources of the documents of the cluster, and a diversity measure of the cluster and determining the most relevant cluster comprises:
applying a weighting factor to at least a portion of the information for the cluster; and
determining the relevance factor for the cluster of documents by determining
$$( \begin{matrix}( SW * rank ( S ) ) + \\ ( CW * rank ( 1 - C ) ) + \\ ( DW * min ( rank ( D ) , rank ( \frac{D}{S} ) ) ) + \\ ( IW * min ( rank ( I ) , rank ( \frac{I}{S} ) ) )\end{matrix} ) * {0.5}^{\frac{Age}{HL}} wherein \text{:}$$
S is the size of the cluster and SW is the weighting factor of the size information;
C is the conciseness measure of the cluster and CW is the weighting factor of the conciseness measure information;
D is the diversity measure of the cluster and is a count of distinct sources of the documents of the cluster and DW is the weighting factor of the diversity measure information;
I is a sum of the relevance measures of the sources of the documents of the cluster and IW is the weighting factor of the relevance measures information;
Age is a relative age of the cluster;
HL is a half life of the Age;
rank( ) is a function that returns a rank from a list of inputs sorted increasingly by value; and
min( ) is a function that returns the minimum of input values.

7. The method of claim 6 wherein determining the relevance factor for the cluster of documents further comprises
$$( \begin{matrix}( SW * rank ( S ) ) + \\ ( CW * rank ( 1 - C ) ) + \\ ( DW * min ( rank ( D ) , rank ( \frac{D}{S} ) ) ) + \\ ( IW * min ( rank ( I ) , rank ( \frac{I}{S} ) ) ) + \\ ( CatW * min ( rank ( Cat ) , rank ( \frac{Cat}{S} ) ) )\end{matrix} ) * {0.5}^{\frac{Age}{HL}}$$
wherein Cat is a category measure included in the information for the document and CatW is the weighting factor of the category measure information.

8. The method of claim 1 wherein the objects are documents in a cluster and determining the relevance factor for the document based on document information further comprises:
$$determining ( \begin{matrix}( DistW * rank ( 1 - Dist ) ) + \\ ( IW * \frac{rank ( I )}{S} ) + \\ ( LW * \frac{gauss ( L , {L}_{M} , STDL )}{gauss ( {L}_{M} , {L}_{M} , STDL )} )\end{matrix} ) * {0.5}^{\frac{Age}{HL}} wherein \text{:}$$
the information for the document includes a numerical distance Dist between a feature vector of the document and a centroid of the cluster, an impact measure I of a source of the document, a document length L, and relative age information Age about the document in relation to the cluster;
S is a size of the cluster;
DistW is a weighting factor of the numerical distance between the feature vector of the document and the centroid of the cluster;
IW is a weighting factor of the impact measure information;
LW is a weighting factor of the document length information;
rank( ) is a function that returns a rank from a list of inputs sorted increasingly by value;
L_{M} is an average length of documents in the cluster; and
gauss( ) is a function that returns a value of a normal probability density function centered at L_{M} with a standard deviation of STDL.

9. The method of claim 1 further comprising:
receiving a query input; and
wherein the object is a cluster comprising one or more documents and determining the relevance factor for the cluster based on cluster information further comprises determining:
a relevance factor of each of the one or more documents based on the received query input; and
$$( \begin{matrix}( RelW * rank ( Rel ) ) + \\ ( Cov W * rank ( Cov ) ) + \\ ( AgeW * rank ( \frac{1}{Age} ) )\end{matrix} ) wherein \text{:}$$
Rel is a relevance measure of the cluster based on the received query input and RelW is a weighting factor of the relevance measure;
Cov is a count of a number of the one or more documents with a determined relevance factor exceeding a predetermined threshold and CovW is a weighting factor of the count;
Age is a relative age between a time of the query input receipt and an age determination of the cluster and AgeW is a weighting factor of the Age; and
rank( ) is a function that returns a rank from a list of inputs sorted increasingly by value.

10. The method of claim 1 further comprising:
receiving a query input; and
wherein the object is a document in a cluster comprising one or more documents and determining the relevance factor for the document based on document information further comprises determining:
$$( \begin{matrix}( RelW * rank ( Rel ) ) + \\ ( Dist W * rank ( Dist ) ) + \\ ( AgeW * rank ( \frac{1}{Age} ) )\end{matrix} ) wherein \text{:}$$
Rel is a relevance measure of the document based on the received query input and RelW is a weighting factor of the relevance measure;
Dist is a numerical distance between the document and a query representation and DistW is a weighting factor of the numerical distance;
Age is a relative age between a time of the query input receipt and an age determination of the document and AgeW is a weighting factor of the Age; and
rank( ) is a function that returns a rank from a list of inputs sorted increasingly by value.

11. The method of claim 10 wherein the query representation is a geographical coordinate of the query and the numerical distance Dist is determined as
$$Dist = 2 * arc sin ( \sqrt{{sin}^{2} ( \frac{{x}_{1} - {x}_{2}}{2} ) + cos ( {x}_{2} ) {sin}^{2} ( \frac{{y}_{1} - {y}_{2}}{2} )} ) wherein \text{:}$$
x₁ is the latitude in radians of the document location;
x₂ is the latitude in radians of the geographical coordinate of the query;
y₁ is the longitude in radians of the document location; and
y₂ is the longitude in radians of the geographical coordinate of the query.

12. A machine readable medium having program instructions stored thereon, the instructions capable of execution by a processor and defining the steps of:
determining an object location;
determining a relevance factor for the object based at least in part on object information including the object location; and
ranking the object in relation to one or more other objects based on the relevance factor.

13. The machine readable medium of claim 12 wherein the objects are documents and the instructions for determining the document location further define the steps of:
determining a frequency of each of one or more geographical coordinates associated with the object;
weighting the geographical coordinates based on the determined frequencies;
determining a mean of weighted geographical coordinates;
determining geographical distance measures between each of the geographical coordinates and the mean of weighted geographical coordinates; and
selecting the geographical coordinate of the closest geographical distance measure as the document location.

14. The machine readable medium of claim 13 wherein the instructions of determining a geographical distance measure between a geographical coordinate and the mean of weighted geographical coordinates further define the steps of:
$$determining 2 * arc sin ( \sqrt{{sin}^{2} ( \frac{{x}_{1} - {x}_{2}}{2} ) + cos ( {x}_{2} ) {sin}^{2} ( \frac{{y}_{1} - {y}_{2}}{2} )} ) wherein \text{:}$$
x₁ is the latitude in radians of the determined mean of the weighted geographical coordinates;
x₂ is the latitude in radians of the geographical coordinate;
y₁ is the longitude in radians of the determined mean of the weighted geographical coordinates; and
y₂ is the longitude in radians of the geographical coordinate.

15. The machine readable medium of claim 12 wherein the objects are documents and the instructions for determining the document location further define the steps of:
determining a frequency of each of the one or more geographical coordinates;
weighting the geographical coordinates based on the determined frequencies;
determining a mean of weighted geographical coordinates; and
selecting the mean of weighted geographical coordinates as the document location.

16. The machine readable medium of claim 12 wherein the objects are clusters and the instructions for ranking the cluster in relation to one or more other clusters further defines the step of:
determining a most relevant cluster.

17. The machine readable medium of claim 16 wherein the information for the cluster includes a size of the cluster, an age of the cluster, a conciseness measure of the cluster, sources of the documents of the cluster, relevance measures of the sources of the documents of the cluster, and a diversity measure of the cluster and the instructions for determining the most relevant cluster further define the steps of:
applying a weighting factor to at least a portion of the information for the cluster; and
determining the relevance factor for the cluster of documents by determining
$$( \begin{matrix}( SW * rank ( S ) ) + \\ ( CW * rank ( 1 - C ) ) + \\ ( DW * min ( rank ( D ) , rank ( \frac{D}{S} ) ) ) + \\ ( IW * min ( rank ( I ) , rank ( \frac{I}{S} ) ) )\end{matrix} ) * {0.5}^{\frac{Age}{HL}} wherein \text{:}$$
S is the size of the cluster and SW is the weighting factor of the size information;
C is the conciseness measure of the cluster and CW is the weighting factor of the conciseness measure information;
D is the diversity measure of the cluster and is a count of distinct sources of the documents of the cluster and DW is the weighting factor of the diversity measure information;
I is a sum of the relevance measures of the sources of the documents of the cluster and IW is the weighting factor of the relevance measures information;
Age is a relative age of the cluster;
HL is a half life of the Age;
rank( ) is a function that returns a rank from a list of inputs sorted increasingly by value; and
min( ) is a function that returns the minimum of input values.

18. The machine readable medium of claim 17 wherein the instructions for determining the relevance factor for the cluster of documents further define the step of:
$$determining ( \begin{matrix}( SW * rank ( S ) ) + \\ ( CW * rank ( 1 - C ) ) + \\ ( DW * min ( rank ( D ) , rank ( \frac{D}{S} ) ) ) + \\ ( IW * min ( rank ( I ) , rank ( \frac{I}{S} ) ) ) + \\ ( CatW * min ( rank ( Cat ) , rank ( \frac{Cat}{S} ) ) )\end{matrix} ) * {0.5}^{\frac{Age}{HL}} wherein Cat is a category$$
measure included in the information for the document and CatW is the weighting factor of the category measure information.

19. The machine readable medium of claim 12 wherein the objects are documents in a cluster and the instructions for determining the relevance factor for the document based on document information further defines the step of:
$$determining ( \begin{matrix}( DistW * rank ( 1 - Dist ) ) + \\ ( IW * \frac{rank ( I )}{S} ) + \\ ( LW * \frac{gauss ( L , {L}_{M} , STDL )}{gauss ( {L}_{M} , {L}_{M} , STDL )} )\end{matrix} ) * {0.5}^{\frac{Age}{HL}} wherein \text{:}$$
the information for the document includes a numerical distance Dist between a feature vector of the document and a centroid of the cluster, an impact measure I of a source of the document, a document length L, and relative age information Age about the document in relation to the cluster;
S is a size of the cluster;
DistW is a weighting factor of the numerical distance between the feature vector of the document and the centroid of the cluster;
IW is a weighting factor of the impact measure information;
LW is a weighting factor of the document length information;
rank( ) is a function that returns a rank from a list of inputs sorted increasingly by value;
L_{M} is an average length of documents in the cluster; and
gauss( ) is a function that returns a value of a normal probability density function centered at L_{M} with a standard deviation of STDL.

20. The machine readable medium of claim 12 wherein the object is a cluster comprising one or more documents and the instructions further define the step of:
receiving a query input; and
the instructions for determining the relevance factor for the cluster based on cluster information further define the step of determining:
a relevance factor of each of the one or more documents based on the received query input; and
$$( \begin{matrix}( RelW * rank ( Rel ) ) + \\ ( Cov W * rank ( Cov ) ) + \\ ( AgeW * rank ( \frac{1}{Age} ) )\end{matrix} ) wherein \text{:}$$
Rel is a relevance measure of the cluster based on the received query input and RelW is a weighting factor of the relevance measure;
Cov is a count of a number of the one or more documents with a determined relevance factor exceeding a predetermined threshold and CovW is a weighting factor of the count;
Age is a relative age between a time of the query input receipt and an age determination of the cluster and AgeW is a weighting factor of the Age; and
rank( ) is a function that returns a rank from a list of inputs sorted increasingly by value.

21. The machine readable medium of claim 12 wherein object is a document in a cluster comprising one or more documents and the instructions further define the steps of:
receiving a query input; and
the instructions for determining the relevance factor for the document based on document information further define the step of determining:
$$( \begin{matrix}( RelW * rank ( Rel ) ) + \\ ( Dist W * rank ( Dist ) ) + \\ ( AgeW * rank ( \frac{1}{Age} ) )\end{matrix} ) wherein \text{:}$$
Rel is a relevance measure of the document based on the received query input and RelW is a weighting factor of the relevance measure;
Dist is a numerical distance between the document and a query representation and DistW is a weighting factor of the numerical distance;
Age is a relative age between a time of the query input receipt and an age determination of the document and AgeW is a weighting factor of the Age; and
rank( ) is a function that returns a rank from a list of inputs sorted increasingly by value.

22. The machine readable medium of claim 21 wherein the query representation is a geographical coordinate of the query and the numerical distance Dist is determined as
$$Dist = 2 * arc sin ( \sqrt{{sin}^{2} ( \frac{{x}_{1} - {x}_{2}}{2} ) + cos ( {x}_{2} ) {sin}^{2} ( \frac{{y}_{1} - {y}_{2}}{2} )} ) wherein \text{:}$$
x₁ is the latitude in radians of the document location;
x₂ is the latitude in radians of the geographical coordinate of the query;
y₁ is the longitude in radians of the document location; and
y₂ is the longitude in radians of the geographical coordinate of the query.
